(19) United States
(12) Patent Application Publication
(10) Pub. No.: US 2014/0131340 A1
(43) Pub. Date: May 15, 2014

(54) HEATING METHOD OF HEATING APPARATUS

(71) Applicant: INDUSTRIAL TECHNOLOGY RESEARCH INSTITUTE, Hsinchu (TW)

(72) Inventors: Ku-Yen Kang, Hsinchu City (TW); Ching-Jung Liu, Hsinchu County (TW); Chun-Ho Tai, Hsinchu City (TW); Shou-Hung Ling, Taipei City (TW)

(73) Assignee: Industrial Technology Research Institute, Hsinchu (TW)

(21) Appl. No.: 13/863,384

(22) Filed: Apr. 16, 2013

(30) Foreign Application Priority Data
Nov. 13, 2012 (TW) 101142261

(51) Int. Cl. H05B 3/00; H05B 1/02; F24J 1/00

(52) U.S. Cl. CPC H05B 3/00; F24J 1/00; H05B 1/02
USPC 219/201

(57) ABSTRACT

A heating method of a heating apparatus is provided. The heating apparatus includes a fuel cell, a power storage device, a heat-electricity conversion element, and a switching unit. The fuel cell is adapted for charging the power storage device. The power storage device is adapted for supplying electricity to the heat-electricity conversion element. The switching unit is adapted for switching the heating apparatus between a first mode and a second mode. The method includes a first heating process in which the fuel cell charges the power storage device and generates heat during a charging process, and a second heating process in which the power storage device supplies electricity to the heat-electricity conversion element and the heat-electricity conversion element generates heat. The first heating process and the second heating process are performed alternatively or simultaneously when the heating apparatus is switched to the first mode or the second mode, respectively.

### CROSS-REFERENCE TO RELATED APPLICATION

This application claims the priority benefit of Taiwan application serial no. 101142261, filed on Nov. 13, 2012. The entirety of the above-mentioned patent application is hereby incorporated by reference herein and made a part of this specification.

### TECHNICAL FIELD

The technical field relates to a heating method of a heating apparatus.

### BACKGROUND

A fuel cell is a device which uses fuel to carry on chemical reactions for generating electricity. The fuel of the fuel cell may be selected from a variety of materials, for example, hydrogen gas, methanol, ethanol, and natural gas.

In an operating fuel cell, the fuel is reacted with oxygen gas through a catalyst to produce water. Some fuel may generate carbon dioxide as well. However, in comparison with other methods for generating electricity, such as thermal power generation, the exhaust amount of carbon dioxide of the operating fuel cell is small, and thus using the fuel cell to generate electricity may be deemed as a low-pollution method.

A direct methanol fuel cell (DMFC) is a device for generating electricity. It converts chemical energy into electricity by directly using methanol (aqueous solution) or methanol gas as the fuel, and the fuel conversion efficiency (i.e., the efficiency of converting chemical energy into electricity) may be changed with the variation in the operative temperatures. In most cases, the fuel efficiency is less than 40%, and the remaining chemical energy is converted into heat. Under normal circumstances, the heat generated by an operating fuel cell is considered as waste heat which needs to be dissipated through a specifically-designed mechanism; alternatively, dissipation of the waste heat may require additional energy. As a result, proper use of the heat generated by the fuel cell may be conducive to improvement of the fuel efficiency.

### SUMMARY

One of exemplary embodiments includes a heating method of a heating apparatus. The heating apparatus includes a fuel cell, a power storage device, a heat-electricity conversion element, and a switching unit. The fuel cell is adapted for charging the power storage device, and the power storage device is adapted for supplying electricity to the heat-electricity conversion element. The switching unit is adapted for switching the heating apparatus between a first mode and a second mode. The heating method of the heating apparatus includes a first heating process in which the fuel cell charges the power storage device and generates heat during a charging process, and a second heating process in which the power storage device supplies electricity to the heat-electricity conversion element and the heat-electricity conversion element generates heat. The first heating process and the second heating process are performed alternatively when the heating apparatus is switched to the first mode, and the first heating process and the second heating process are performed simultaneously when the heating apparatus is switched to the second mode.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic diagram illustrating a heating process of a heating apparatus according to a first exemplary embodiment of the disclosure.

FIG. 2 is a block diagram illustrating the heating apparatus according to the first exemplary embodiment of the disclosure.

FIG. 3 is a block diagram illustrating the heating apparatus according to another exemplary embodiment of the disclosure.

FIG. 4A is a schematic diagram illustrating an experimental result of experimental example 1.

FIG. 4B is a schematic diagram illustrating an experimental result of experimental example 2.

### DETAILED DESCRIPTION OF DISCLOSED EMBODIMENTS

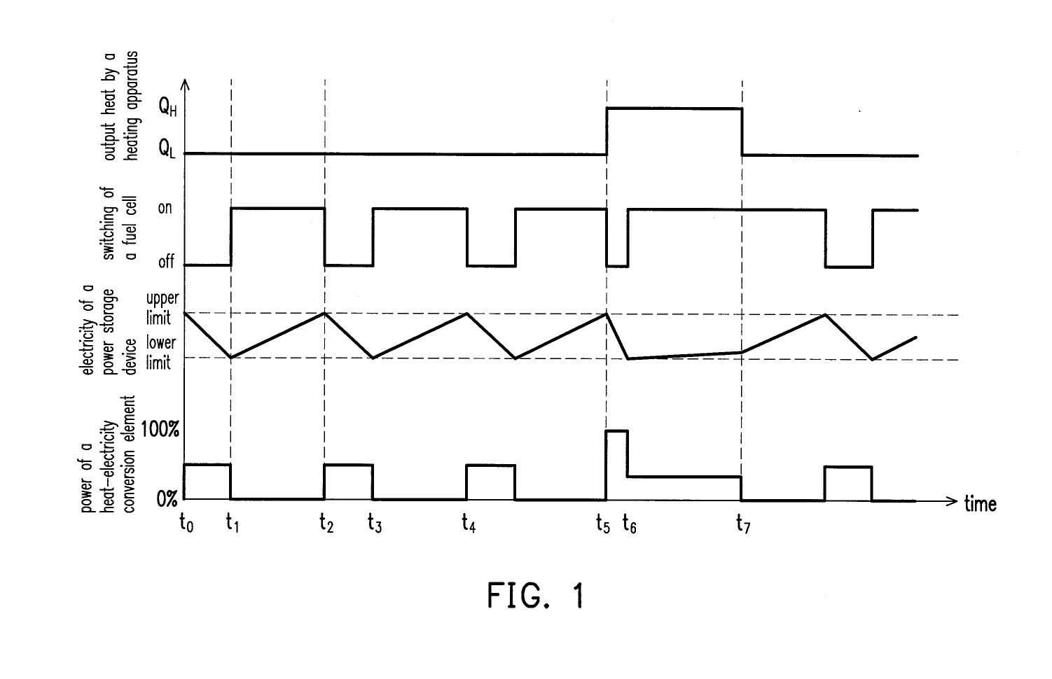

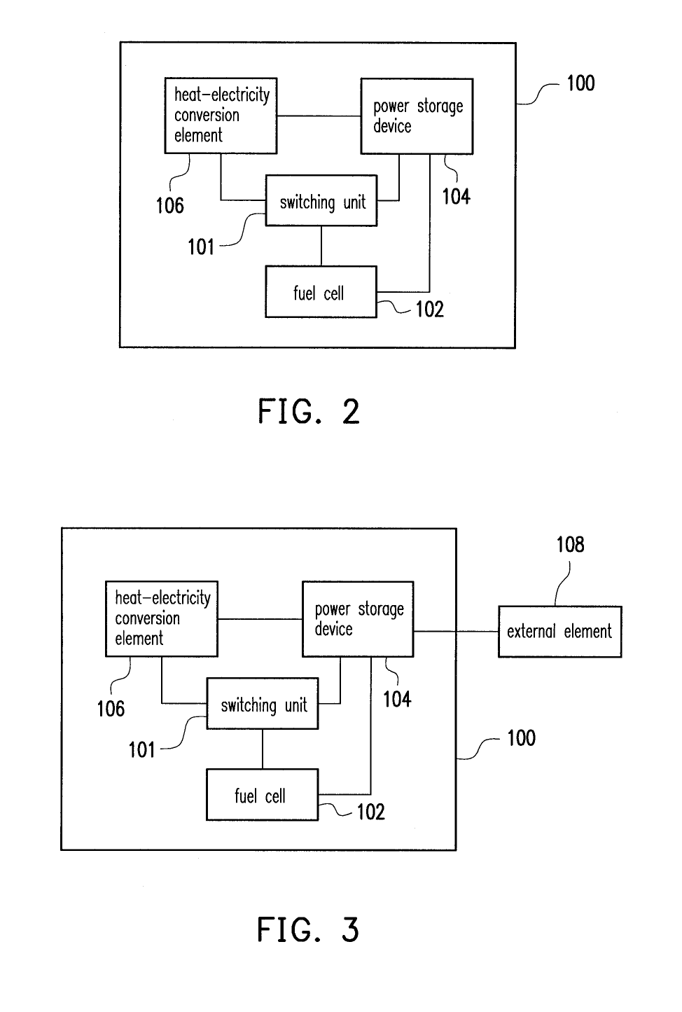

FIG. 1 is a schematic diagram illustrating a heating process of a heating apparatus according to a first exemplary embodiment of the disclosure. FIG. 2 is a block diagram illustrating the heating apparatus according to the first exemplary embodiment of the disclosure. In FIG. 1, the variation in heat output by a heating apparatus, an on/off state of a fuel cell, an electricity change of a power storage device, and a power change of a heat-electricity conversion element are exhibited at the same time axis, so as to clearly exhibit the heating method of the heating apparatus in the first exemplary embodiment of the disclosure.

With reference to FIG. 2, according to the first exemplary embodiment, the heating apparatus 100 includes a switching unit 101, a fuel cell 102, a power storage device 104, and a heat-electricity conversion element 106. The fuel cell 102 is electrically connected with the power storage device 104, and is adapted for charging the power storage device 104. Voltage conversion elements (not shown) may be added into the heating apparatus 100, if necessary. The power storage device 104 is electrically connected with the heat-electricity conversion element 106, and is adapted for supplying electricity to the heat-electricity conversion element 106. The switching unit 101 may, in response to users' demands, control the amount of heat output by the heating apparatus 100, which will be described in detail below.

The term “a power storage device” in the disclosure refers to a rechargeable device, and the power storage device may be a secondary battery or a capacitor. For example, a secondary battery may be a lead acid battery, a nickel cadmium battery, a nickel hydride battery, or a lithium ion battery. Of course, the embodiments of the disclosure do not limit the type of the power storage device; as long as the device can be charged by a fuel cell and supply electricity to another electronic element, the device falls within the scope of the disclosure.

The term “a heat-electricity conversion element” refers to an element which can make heat exchange with an external environment by consuming electricity. The term “heat exchange with an external environment” here indicates an action of transferring heat to the external environment. Here, the heat-electricity conversion element may be a resistive heater, for instance. The heat-electricity conversion element may also be a thermoelectric element composed of thermoelectric materials. The thermoelectric element has a cool end and a hot end, and as a result, in the present exemplary embodiment, the heat-electricity conversion element may cool down the external environment or heat up the external environment according to actual requirements.

The operative principle of the fuel cell is to convert chemical energy into electricity through a chemical reaction. Not only electricity but also a large amount of heat may be generated during the reaction. Taking a DMFC with the fuel efficiency of 20.8% as an example, about 4800 Wh (watts×hours) of energy may be obtained by consuming 1 L of methanol, wherein about 1000 Wh of energy is electrical energy, and about 3800 Wh of energy is heat. The heating method described in the exemplary embodiment of the disclosure is a method of exploiting heat generating during the operation of the fuel cell.

In the first embodiment, the heating apparatus 100 is a portable heating apparatus, such as a body-warming apparatus, a camera package, a heat preservation backpack, etc. In consideration of portability, the volume of the fuel cell 102 is often small, and the power output by the fuel cell 102 may be less than 50 W, for example, less than 10 W. Moreover, an internal temperature (that is, the reaction temperature of the chemical reaction in the fuel cell) of an operating fuel cell 102 may be lower than 70° C., for example, lower than 60° C. The fuel cell 102 described in this exemplary embodiment may be arbitrarily placed in any orientation, and the fuel cell 102 may be the one disclosed in Taiwan patent application No. 99144306. The fuel of the fuel cell 102 may be a methanol solution with a concentration greater than 50% v/v, and the fuel with the high concentration directly reacts on an anode of a membrane electrode assembly of the fuel cell 102 without being diluted in a mixing tank.

With reference to FIG. 1, the heating apparatus 100 is turned on at the time t₀. For clear explanation, the description below is based on the assumptions as follows: the electricity of the power storage device 104 is saturated (i.e. the electricity reaches a predetermined upper limit) at the time t₀; at this time, a user requires less heat, i.e., less heat is output by the heating apparatus 100. Switches that correspond to different requirements (e.g., strong output or weak output) may be disposed on the heating apparatus 100, and the user may make selection according to his or her actual needs. In one exemplary embodiment, the switches may be connected to the switching unit 101, so that the heating apparatus 100 may be switched to a state (e.g. a first mode) in which less heat is supplied. Situations where the user requires more heat will be described in detail below. Certainly, the actual use of the heating apparatus 100 is not subject to the aforementioned conditions. After the heating apparatus 100 is turned on (when t>t₀), there is no need to turn on the fuel cell 102 because the electricity of the power storage device 104 has reached the upper limit. At this time, the power storage device 104 supplies electricity to the heat-electricity conversion element 106, so that the heat-electricity conversion element 106 is turned on and generates the heat. Since the amount of heat supplied by the heating apparatus 100 is relatively small, the power of the heat-electricity conversion element 106 is not required to reach the maximum level. That is, the power of the heat-electricity conversion element 106 can be adjusted; for example, the power may only reach 50% of the maximum level, as shown in FIG. 1. At this time, the heat Q_{L} is output to the external environment by the heating apparatus 100. In an example, the heating apparatus 100 may be a handheld heating apparatus, so that the heat Q_{L} output by the heating apparatus 100 may make the user feel warm. Alternatively, for example, the heating apparatus 100 may be a heating apparatus in a backpack, so that the heat Q_{L} may be output to the heat preservation space in the backpack; thereby, the temperature in the heat preservation space is higher than the ambient temperature.

The electricity of the heat-electricity conversion element 106 may be supplied by the power storage device 104, and thus the electricity of the power storage device 104 is reduced gradually as the time goes by. At the time t₁, the electricity of the power storage device 104 is reduced to the predetermined lower limit. At this time, a first heating process is performed. In the first heating process, the fuel cell 102 is turned on and generates electricity to charge the power storage device 104. A voltage conversion device (not shown) may be disposed between the fuel cell 102 and the power storage device 104 if necessary. In addition to electricity generation, heat is also generated when the fuel cell 102 is turned on. Therefore, the heat required by the user (Q_{L}) can now be supplied by the fuel cell 102, rather than the heat-electricity conversion element 106. As a result, the heat-electricity conversion element 106 can be turned off when the fuel cell 102 is turned on (at the time t₁).

In the time frame from t₁ to t₂, the power storage device 104 is charged by the fuel cell 102, so that the electricity of the power storage device 104 is increased gradually; at the same time, heat is generated by the fuel cell 102 to supply the heat Q_{L}. At the time t₂, the electricity of the power storage device 104 reaches the predetermined upper limit, so that the fuel cell 102 is turned off. A second heating process is then performed; that is, the heat Q_{L} required to be supplied by the heating apparatus 100 is provided by the heat-electricity conversion element 106 now, which is similar to the condition at the time t₀.

In this disclosure, “a first heating process” refers to a process in which the fuel cell 102 charges the power storage device 104 and generates heat during the charging process (i.e., the heating process during the time frame from t₁ to t₂), and “a second heating process” refers to a process in which the power storage device 104 supplies electricity to the heat-electricity conversion element 106, and the heat-electricity conversion element 106 generates heat (i.e., the heating process during the time frame from t₀ to t₁). The terms “first” and “second” are used to distinguish the two heating processes but not to define the sequence of the two heating processes. As a matter of fact, the first heating process and the second heating process may be performed alternatively (during the time frame from t₀ to t₂) or simultaneously (which will be described in detail below).

The heating process during the time frame from t₂ to t₃ is the same as that from t₀ to t₁; the heating process during the time frame from t₃ to t₄ is the same as that from t₁ to t₂, and so on. In case that the heating apparatus 100 is switched to the first mode, the first heating process and the second heating process described above may be constantly performed in an alternative manner. That is, the heating process in the first embodiment can supply heat stably as long as the fuel of the fuel cell 102 has not been completely consumed. To be more specific, the conventional portable heating apparatuses generate heat through consumption of electricity (i.e., the conventional portable heating apparatuses convert electricity into heat); however, after the electricity has been completely consumed, the conventional portable heating apparatuses can no longer generate heat nor generate and store electricity. To generate heat again, the conventional portable heating apparatuses must be charged from the external electricity. By contrast, the heating process described in the first embodiment not only generates heat through consumption of electricity (i.e., the heat-electricity conversion element 106 is applied to convert electricity into heat) but also generates heat at the time of generating and storing electricity (i.e., the fuel cell 102 is applied to convert chemical energy into heat). Thereby, heat may be constantly output to the external environment for a long time.

As shown in FIG. 1, at the time t₅, the electricity of the power storage device 104 reaches the upper limit again, and thus the fuel cell 102 is turned off. In order to maintain the heat output, the heat-electricity conversion element 106 is turned on. At this time, if more heat is required by the user, the user can adjust the aforementioned switches to “strong”. In response to the switching action, the switching unit 101 may increase the power of the heat-electricity conversion element 106, so that the a relatively large amount of heat (Q_{H}) may be output by the heating apparatus 100. Since the power of the heat-electricity conversion element 106 is increased, the electricity consumption of the power storage device 104 is accelerated. As shown in FIG. 1, the slope of the curve representing electricity of the power storage device 104, is sharper between t₅ and t₆ than the slope of the curve between t₀ and t₁ (or between t₂ and t₃). When the electricity of the power storage device 104 reaches the lower limit (at the time t₆), the switching unit 101 may switch the heating apparatus 100 to the second mode, and thereby the fuel cell 102 is turned on. At this time, the fuel cell 102 and the heat-electricity conversion element 106 generate heat together, which means that the first heating process and the second heating process are performed simultaneously when the heating apparatus 100 is switched to the second mode. Furthermore, the power of the heat-electricity conversion element 106 can be reduced because the fuel cell 102 may supply certain amount of heat, and thereby the electricity consumption of the power storage device 104 is reduced. As long as the power generation efficiency of the fuel cell 102 is sufficient, the electricity of the power storage device 104 may still gradually increase even if the power storage device 104 at the same time supplies electricity to the heat-electricity conversion element 106.

At the time t₇, if the heating apparatus 100 is no longer required to output the heat Q_{H}, the heating apparatus 100 is switched to the first mode, and thereby the heat-electricity conversion element 106 can be turned off. At this time, the heat Q_{L} (with the relatively small amount of heat) output by the heating apparatus 100 may be independently supplied by the fuel cell 102, and the fuel cell 102 may continuously charge the power storage device 104. As a result, the first heating process and the second heating process may be subsequently performed alternately.

In the previous embodiments, the situation in which the heat-electricity conversion element 106 is used to generate heat is described; however, the heat-electricity conversion element 106 may also be employed to perform a cooling process. For example, given that the power storage device 104 is charged by the fuel cell 102, if the fuel cell 102 generates an excessive amount of heat, and the resultant temperature of the heating apparatus 100 is overly high, the heat-electricity conversion element 106 may be switched to a mode in which electricity is consumed to remove the excessive amount of heat; thereby, the temperature of the heating apparatus 100 can be fine tuned.

In addition, based on the user's requirement for heat, the fuel cell may be in an operative mode with low fuel efficiency (i.e., the mode in which the power generation efficiency is reduced and the thermal generation efficiency is increased in case that the same amount of fuel is given) to generate more heat. For instance, the operative voltage may be lowered down, or an increasing amount of fuel may be used for reactions.

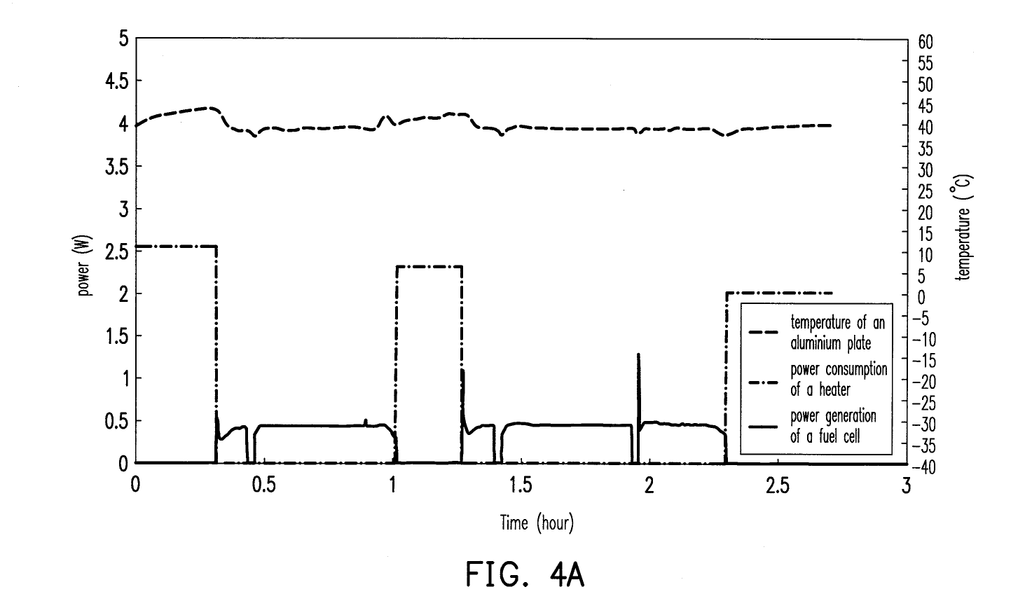

Moreover, in this exemplary embodiment, it is not necessary to transmit the electricity of the power storage device 104 only to the heat-electricity conversion element 106. The electricity of the power storage device 104 may be supplied to an external element 108 electrically connected with the power storage device 104 as long as there is a proper power output installed in the heating apparatus 100, as shown in FIG. 3. The external element 108 may be a portable 3C product, such as a mobile phone, an mp3 player, a personal digital assistant (PDA), etc. Based on the requirement of the external element 108, a voltage conversion device (not shown) may be further disposed between the power storage device 104 and the external element 108.

The heating apparatus 100 may further include a temperature detecting unit (not shown), an electricity detecting unit (not shown), and a control unit (not shown). The temperature detecting unit can detect the temperature of the heating apparatus 100; for example, the temperature detecting unit may be designed to detect the temperature of a portion of the heating apparatus 100 in contact with the human body when the heating apparatus 100 is a body-warming apparatus; the power detecting unit can detect the remaining electricity of the power storage device 104; the control unit can determine whether to turn on/off the fuel cell 102, whether to turn on/off the heat-electricity conversion element 106, and the power of the operating heat-electricity conversion element 106 according to the information obtained from the temperature detecting device and the electricity detecting device. The structures of the aforementioned elements, the actual configurations of these elements, and the circuitry connection correlations among these elements may be known to people having ordinary skill in the pertinent art, and the relevant descriptions may thus be omitted hereinafter.

### Experiments

Experimental examples are listed below to further explain a heating method of a heating apparatus according to the embodiments of the disclosure. However, the disclosure is not limited to the following experimental examples.

### Experimental Example 1

The heating apparatus used in experimental example 1 includes a direct methanol fuel cell system which includes a fuel cell, a moisturizing layer at a cathode terminal of the fuel cell, a fuel distribution unit at an anode terminal of the fuel cell, a control unit, a liquid fuel replenishment device, a fuel storage region, and a temperature detecting device. The liquid fuel replenishment device is controlled by the control unit to transfer highly-concentrated methanol fuel (68% of methanol aqueous solution) in the fuel storage region to the fuel distribution unit and further distribute the highly-concentrated methanol fuel to the fuel cell. The temperature detecting device detects an actual temperature of the fuel cell and provides the information about the temperature to the control unit. The control unit controls the operative temperature of the fuel cell to be at most 60° C.

An aluminium plate with a thickness of 300 μm is used as a heat conducting plate, and a resistive heater (a PI film heater occupying an area of 1×3 cm²) is disposed on the aluminium plate. The aluminium plate is in direct contact with the fuel cell to conduct the heat generated by the fuel cell. A lithium ion battery is further disposed in the heating apparatus. Such a structure is used as a basic model of the heating apparatus.

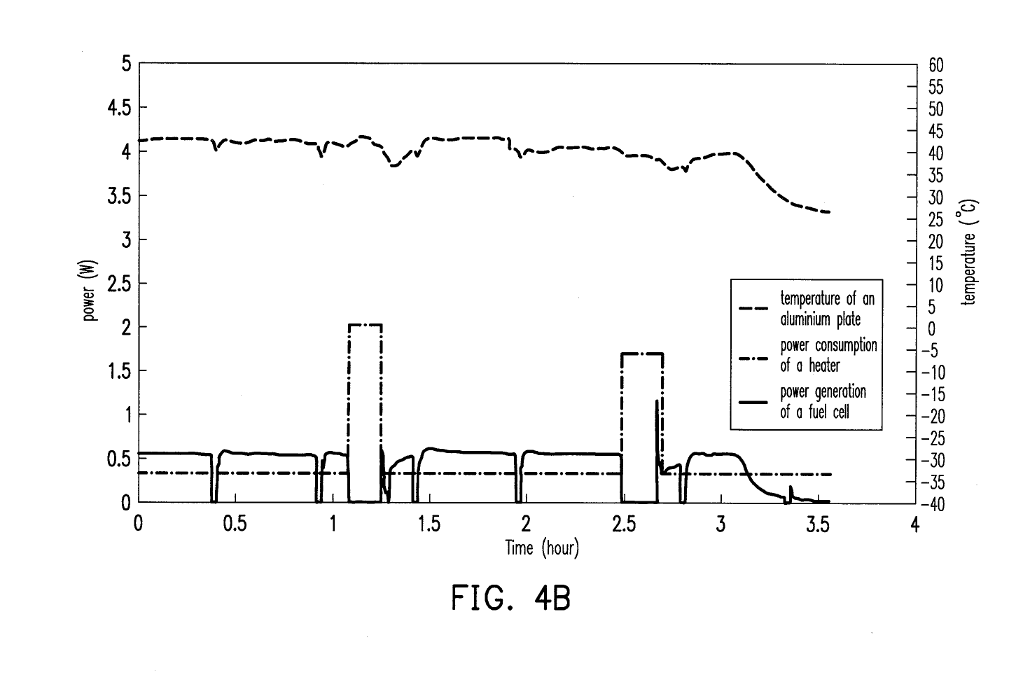

FIG. 4A is a schematic diagram illustrating the experimental result of the experimental example 1. In FIG. 4A, the left longitudinal axis exhibits the power of the heater and the power of the fuel cell, and the right longitudinal axis exhibits the temperature of the aluminium plate. In experimental example 1, first, the aluminium plate is heated by the heater for about 0.3 hour, and the heater is turned off and the fuel cell is turned on, such that the fuel cell charges a secondary battery and continuously generates heat. The equalization that the power consumption of the heater is equal to the charging amount of the secondary battery by the fuel cell is intentionally kept during the experiment, and the system can be operated stably for a long time without external loads. Practically, if there is a need to output electricity, the ratio of power consumption of the heater/power generation of the fuel cell can be adjusted to output electricity to the external environment.

In experimental example 1, under the room temperature at 20° C., the heating process performed by the resistive heater and the heating process resulting from the electricity generation of the fuel cell proceed alternately to stably maintain the temperature of the aluminium plate at 37° C.˜43° C.

### Experimental Example 2

The arrangement of the heating apparatus in experimental example 2 is the same as that in experimental example 1. The difference between experimental example 2 and experimental example 1 lies in that experimental example 2 is conducted under the room temperature at 15° C.

FIG. 4B is a schematic diagram illustrating the experimental result of the experimental example 2. In FIG. 4B, the left longitudinal axis exhibits the power of the heater and the power of the fuel cell, and the right longitudinal axis exhibits the temperature of the aluminium plate. Due to the lower ambient temperature, if the aluminium plate is to be heated to the same temperature (37° C.˜43° C.) as that in experimental example 2, the heating apparatus must output more heat. Therefore, in experimental example 2, the aluminium plate is heated both by the heater and by the fuel cell, while the fuel cell charges the secondary battery at the same time. After the heating process is performed for about 1.1 hours, the fuel cell is turned off, and the heater is solely used for heating. After the heating process is performed for about 1.25 hours, the fuel cell is turned on again, the power of the heater is reduced, and the heating keeps going. The equalization that the power consumption of the heater is equal to the charging amount of the fuel cell is intentionally kept during the experiment.

As described above, a fuel cell, a heat-electricity conversion element, and a power storage device are collectively employed to conduct a method for using the heat generated by the operating fuel cell. Thus, the fuel efficiency is increased, and the energy may not be wasted. The heating method described in the embodiments of the disclosure can achieve the heating (warming) effects through an electricity generation process and an electricity consumption process, which can proceed alternately or simultaneously. Therefore, the system can be stably operated for a long time without external loads, and stable and long-term heat output may be ensured. At the time of electricity generation together with heat generation, if there is any external electricity requirement, for example, by the peripheral 3C products, electricity may also be supplied thereto.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A heating method of a heating apparatus, the heating apparatus comprising:
at least one fuel cell, at least one power storage device, at least one heat-electricity conversion element, and a switching unit,
wherein the at least one fuel cell is adapted for charging the at least one power storage device, the at least one power storage device is adapted for supplying electricity to the at least one heat-electricity conversion element, and the switching unit is adapted for switching the heating apparatus between a first mode and a second mode,
wherein the heating method comprises:
a first heating process in which the at least one fuel cell charges the at least one power storage device and generates heat during a charging process; and
a second heating process in which the at least one power storage device supplies electricity to the at least one heat-electricity conversion element and the at least one heat-electricity conversion element generates heat,
wherein the first heating process and the second heating process are performed alternatively when the heating apparatus is switched to the first mode, and the first heating process and the second heating process are performed simultaneously when the heating apparatus is switched to the second mode.

2. The heating method of claim 1, wherein:
the fuel cell is turned on to perform the first heating process when power of the power storage device reaches a predetermined lower limit; and
the fuel cell is turned off and the second heating process is performed when the power of the power storage device reaches a predetermined upper limit.

3. The heating method of claim 1, wherein the first heating process comprises turning on the at least one fuel cell to generate electricity so as to charge the at least one power storage device, and heat required by the heating apparatus is supplied by heat generated by the at least one fuel cell.

4. The heating method of claim 1, wherein as the heating apparatus is in the first mode, the at least one heat-electricity conversion element is turned off when the at least one fuel cell is turned on.

5. The heating method of claim 1, wherein the second heating process comprises:
supplying electricity to the at least one heat-electricity conversion element by the at least one power storage device to turn on the at least one heat-electricity conversion element and generating heat by the at least one heat-electricity conversion element.

6. The heating method of claim 5, wherein the second heating process further comprises:
adjusting power of the at least one heat-electricity conversion element.

7. The heating method of claim 1, further comprising:
reducing an operative voltage of the at least one fuel cell or increasing a fuel consumption amount of the at least one fuel cell when the heating apparatus is switched to the second mode.

8. The heating method of claim 1, wherein the at least one fuel cell is a direct methanol fuel cell, and fuel of the at least one fuel cell is a methanol solution with a concentration greater than 50% v/v.

9. The heating method of claim 8, wherein the fuel of the at least one fuel cell directly reacts on an anode of a membrane electrode assembly of the at least one fuel cell.

10. The heating method of claim 1, wherein power output by the at least one fuel cell is less than 50 W.

11. The heating method of claim 10, wherein the power output by the at least one fuel cell is less than 10 W.

12. The heating method of claim 1, wherein an internal temperature is lower than 70° C. when the at least one fuel cell is operated.

13. The heating method of claim 12, wherein the internal temperature is lower than 60° C. when the at least one fuel cell is operated.

14. The heating method of claim 1, further comprising supplying electricity to an external element by the at least one power storage device.

15. The heating method of claim 1, wherein the at least one power storage device comprises a secondary battery or a capacitor.

16. The heating method of claim 1, wherein the at least one heat-electricity conversion element comprises a resistive heater or a thermoelectric element.
